(19) United States
(12) Patent Application Publication
(10) Pub. No.: US 2016/0041761 A1
(43) Pub. Date: Feb. 11, 2016

(54) INDEPENDENTLY CONTROLLING SEPARATE MEMORY DEVICES WITHIN A RANK

(71) Applicant: QUALCOMM Incorporated, San Diego, CA (US)

(72) Inventor: Patrick Bartholomew MORAN, La Jolla, CA (US)

(21) Appl. No.: 14/455,002

(22) Filed: Aug. 8, 2014

(51) Int. Cl. G06F 3/06; G06F 12/02

(52) U.S. Cl. CPC G06F 3/0604; G06F 12/023; G06F 3/0635; G06F 3/0644; G06F 3/0659; G06F 3/0683; G06F 2212/1044; G06F 2212/21; G06F 2212/261

(57) ABSTRACT

Multiple memory devices within a rank may be accessed individually by assigning respective device identifiers to memory devices within a rank and/or including an indicator on respective portions of a data path that are coupled to different devices within a rank. A device identifier assignment command is implemented during memory system initialization to assign the device identifiers. Device identifiers are sent to corresponding memory devices in the rank via the data path when the device identifier assignment command is asserted. Device identifier fields are added to certain commands in a command path protocol. Individual memory devices within a rank are addressable by including their respective device identifier in the device identifier field of a memory command on the command path. Individual memory devices within a rank may also be accessed by configuring the devices to execute commands only when an indicator is received on their respective portion of the data path.

### TECHNICAL FIELD

The present disclosure relates generally to semiconductor memory subsystems. More specifically, the present disclosure relates to independently accessing devices within a rank of memory.

### BACKGROUND

Dynamic random access memory (DRAM) may include multiple memory devices that are logically combined into ranks and coupled to a memory controller on a corresponding memory channel. The organization of system memory into ranks can provide increased memory density. The configuration and density of components on a memory subsystem define a number of ranks. Each rank of a memory module forms an identical arrangement of memory components.

### SUMMARY

A method of sending independent commands to multiple memory devices within a rank includes assigning a first device identifier to a first device in the rank and a second identifier to a second device within the rank. This assignment may be performed by sending the first device identifier and the second device identifier on a data path coupled to the first memory device and the second memory device while an identifier assignment command is asserted on a command path shared between the first device and the second device. The method also includes asserting the first device identifier on the command path to address the first device without addressing the second device.

A method of controlling a memory system includes asserting a device identifier assignment command on a command path coupled to a first memory device and a second memory device within a rank. The method also includes writing a first device identifier to the first memory device via a data path coupled to the first memory device and the second memory device while the device identifier assignment command is asserted on the command path, and writing a second device identifier to the second memory device via the data path while the device identifier assignment command is asserted on the command path.

A method of sending independent commands to multiple memory devices within a rank according to another aspect of the present disclosure includes receiving an indicator on a data path independently coupled to a first device in the rank and a second device in the rank and receiving a command by the first device and the second device over a command path shared between the first device and the second device. The method also includes executing the command by either the first device or the second device based at least in part on the indicator received over the data path.

Another aspect of the present disclosure includes a semiconductor package on package (PoP) apparatus. The PoP apparatus includes a first package including a memory controller and a second package coupled to the first package. The second package includes a first memory device within a rank and a second memory device within the rank. A command path is coupled to the first memory device within the rank. A first portion of a data path is coupled to the first memory device and a second portion of the data path coupled to the second memory device. The PoP apparatus also includes means for asserting a device identifier assignment command on a command path coupled to a first memory device and a second memory device within a rank, and means for writing a first device identifier to the first memory device via a data path coupled to the first memory device and a second memory device while the device identifier assignment command is asserted on the command path. The apparatus also includes means for writing a second device identifier to the second memory device via the data path while the device identifier assignment command is asserted on the command path.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram conceptually illustrating a general example of a memory subsystem including multiple memory devices and memory ranks.

FIGS. 2A and 2B are diagrams conceptually illustrating accessing multiple memory devices within a rank according to an aspect of the present disclosure.

FIG. 3 is a process flow diagram illustrating a method for accessing multiple memory devices within a rank according to an aspect of the present disclosure.

FIG. 4 is a process flow diagram illustrating a method for controlling a memory system according to an aspect of the present disclosure.

FIG. 5 is a diagram conceptually illustrating a method and apparatus for addressing different devices within a rank according to an aspect of the present disclosure.

FIG. 6 is a process flow diagram illustrating a method for addressing different devices within a rank according to an aspect of the present disclosure.

FIG. 7 is a process flow diagram illustrating method for sending independent commands to multiple memory devices within a rank according to aspects of the present disclosure.

FIG. 8 is a block diagram illustrating a package on package (PoP) apparatus according to aspects of the present disclosure.

FIG. 9 shows an exemplary wireless communication system in which a configuration of the disclosure may be advantageously employed.

FIG. 10 is a block diagram illustrating a design workstation for circuit, layout, and logic design of a semiconductor component according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In some memory subsystems, it may be desirable to address memory devices within a rank separately. For example, sending separate calibration commands to memories within a rank may allow sharing of calibration resources, such as dedicated calibration balls on a package and external calibration resistors. Sending separate calibration commands to memories within a rank also allows programming different operating values into each memory device to improve or even optimize system performance. Because multiple memory devices in a rank share command inputs, however, they cannot be addressed separately through the command path alone. Aspects of the present disclosure facilitate use of information on a data (“DQ”) path or another non-command path signal to allow for enumeration of devices within a rank. A DQ path may include data and other associated signals such as strobes, data mask signals and/or data inversion signals for example.

An aspect of the present disclosure includes a method for accessing multiple memory devices within a rank by assigning separate device identifiers (IDs) to different memory devices within the rank. A memory command to be used during memory system initialization is added to an existing memory command path protocol for assigning device ID's to respective memory devices. In a second step, device ID fields are added to an existing command path protocol where it is desirable to address different devices within a rank.

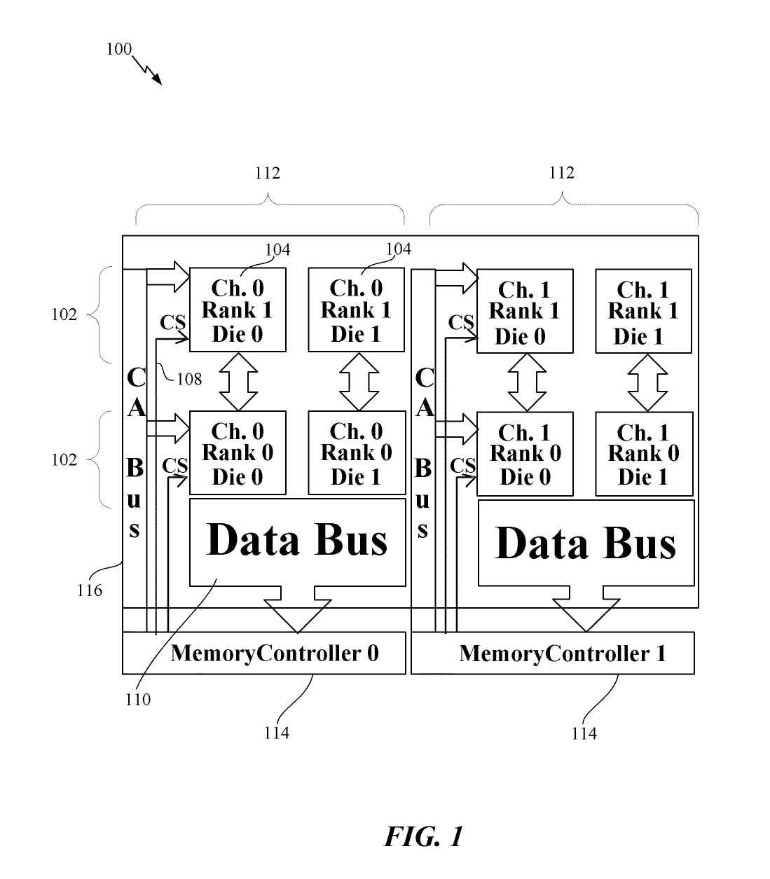

FIG. 1 is a diagram conceptually illustrating a general example of a memory subsystem including multiple memory devices and memory ranks. Representatively, a rank 102 includes a set of memory devices 104 (e.g., dynamic random access memory (DRAM)) in a memory subsystem 100, which are coupled to the same chip select path (CS path) 108, and accessed simultaneously. For example, the memory devices 104 may be individual memory dies. The memory devices 104 in a rank 102 share command and control signals on the common CS path 108. Data pins for each of the memory devices 104 are separate but may be shared across the ranks. For example, the data path 110 of each rank may have a 64-bit width. The number of memory devices 104 in a rank 102 depends on the data path 110 width of each the memory devices 104. For example, a 64-bit rank may include eight 8-bit ones of the memory devices 104 or four 16-bit ones of the memory devices 104.

FIG. 1 further illustrate a memory subsystem 100 that includes multiple of the rank 102 of memory configured on one or more memory channels 112. Each memory channel is coupled to a respective memory controller 114. Multiple ranks (e.g., rank 102) may be arranged on a single package to increase the memory density for each of the memory channels 112. The ranks (e.g., rank 102) of the memory subsystem 100 can be accessed independently so that a memory controller 114 can write data to one of rank 102 while reading data from another rank 102. Conventionally, multiple DRAM devices in a rank are not separately addressable.

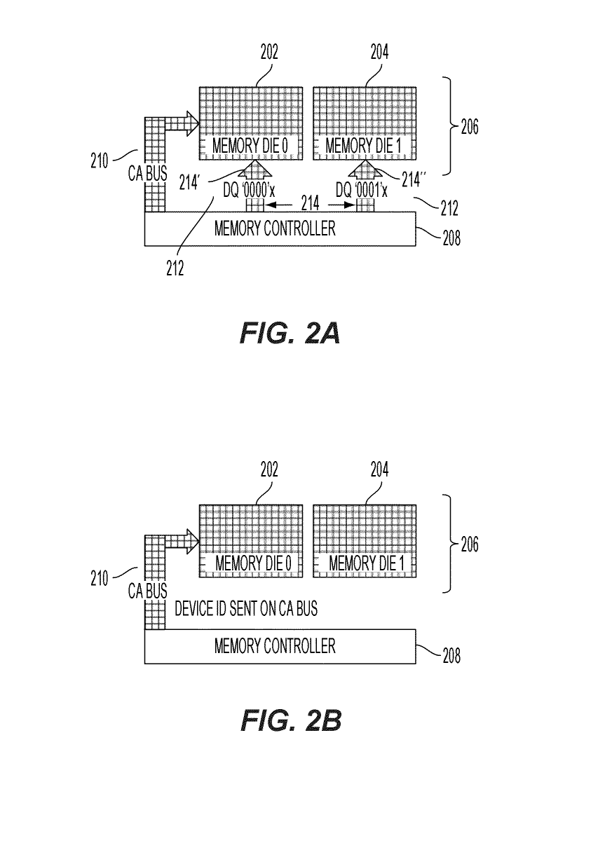

FIGS. 2A and 2B are diagrams conceptually illustrating accessing of multiple memory devices within a rank according to an aspect of the present disclosure. A method for accessing multiple memory devices within a rank according to an aspect of the present disclosure is described with respect to FIG. 2A. During a power-up process of a memory system, each of the first memory device 202 and the second memory device 204 in a rank 206 is assigned a default identifier. The default identifier for each memory device may be an ID of ‘0’ for example. According to one aspect of the present disclosure, the default ID may be assigned to the first memory device 202 and the second memory device 204 by a memory controller 208 during the power-up process. According to another aspect of the present disclosure, each of the first memory device 202 and the second memory device 204 may be configured to automatically store the default ID during the power-up process.

The memory controller 208 optionally sends an ‘assign device ID’ command on the CA path 210. When the memory controller 208 sends the ‘assign device ID’ command, the memory controller 208 also sends a device ID 212 on a data path (DQ path) 214 that is unique to each memory die. A first portion 214′ of the DQ path 214 is coupled to the first memory device 202 and a second portion 214″ of the DQ path 214 is coupled to the second memory device 204. Each of the first memory device 202 and the second memory device 204 stores the device ID that was received via the first portion 214′ or the second portion 214″ of the DQ path 214. A device ID field is also added to selected existing commands

Referring to FIG. 2B, during normal operation, when a command including a device ID field is issued on the CA path 210, the first memory device 202 or the second memory device 204 executes the command only if the device ID 212 of the first memory device 202 or the second memory device 204 matches the device ID included in the device ID field of the command According to this aspect of the present disclosure, multiple commands may be sent on a CA path 210 along with different device ID's 212 to address different memory devices in a rank based on their default or assigned device IDs.

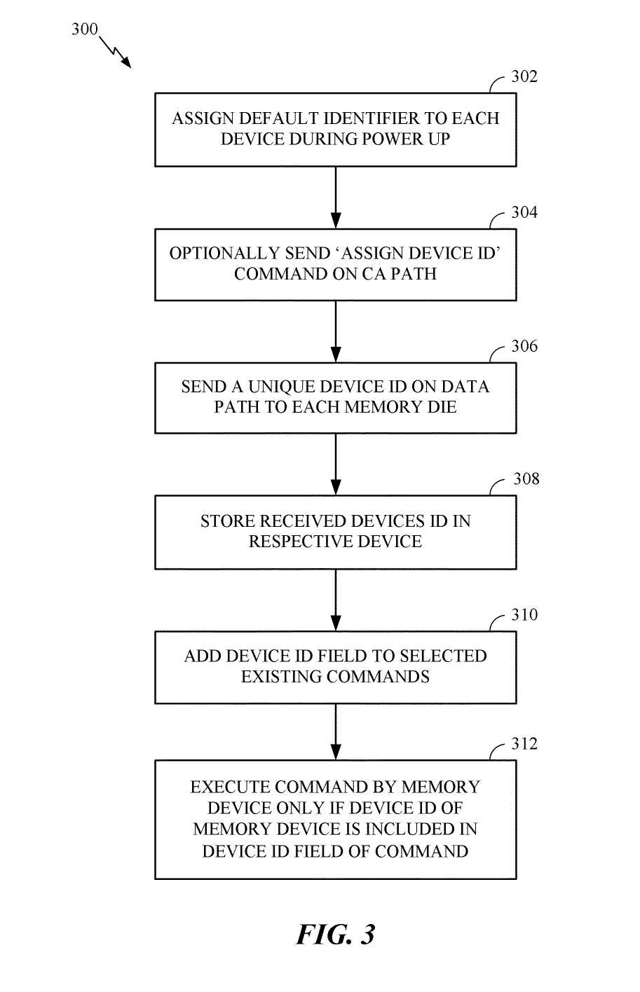

FIG. 3 is a process flow diagram illustrating a method 300 for accessing multiple memory devices within a rank according to an aspect of the present disclosure. At block 302, during a power-up process of a memory system, each memory device in a rank is assigned a default identifier. The default identifier for each memory device may be an ID of ‘0’ for example. According to one aspect of the present disclosure, the default ID may be assigned to each memory device by a memory controller during the power-up process. According to another aspect of the present disclosure, each memory device may be configured to automatically store the default ID during the power-up process.

At block 304, the memory controller optionally sends an ‘assign device ID’ command on the CA path. At block 306, when the memory controller sends the ‘assign device ID’ command, the memory controller also sends a unique device ID on a data path (DQ path) to each memory die. At block 308, the memory device stores its device ID that was received via the DQ path.

At block 310, a device ID field is added to selected existing commands At block 312, during normal operation, when a command including a device ID field is issued on the CA path, a memory device executes the command only if the device ID of the memory device matches the device ID included in the device ID field of the command According to this aspect of the present disclosure, multiple commands may be sent on a CA path along with different device ID's to address different memory devices in a rank based on their default or assigned device IDs.

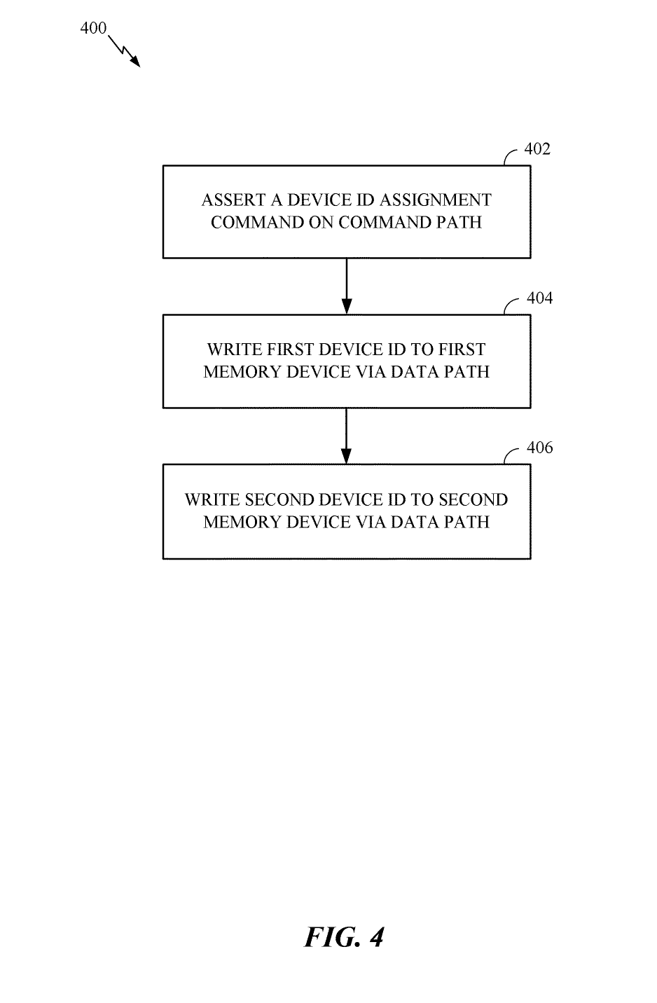

Referring to FIG. 4, a method 400 of controlling a memory system according to an aspect of the present disclosure includes asserting a device identifier assignment command on a command path coupled to a first memory device and a second memory device within a rank at block 402. The method includes writing a first device identifier to the first memory device via a data path coupled to the first memory device and a second memory device while the device identifier assignment command is asserted on the command path at block 404. The method also includes writing a second device identifier to the second memory device via the data path while the device identifier assignment command is asserted on the command path at block 406. According to an aspect of the present disclosure, the method also includes asserting the first device identifier on the command path to address the first device without addressing the second device.

Another aspect of the present disclosure includes a semiconductor package on package (PoP) apparatus includes a first package including a memory controller and a second package coupled to the first package. The second package includes a first memory device within a rank and a second memory device within the rank. A command path is coupled to the first memory device within the rank. A first portion of a data path is coupled to the first memory device and a second portion of the data path coupled to the second memory device. The PoP apparatus includes means for asserting a device identifier assignment command on a command path coupled to a first memory device and a second memory device within a rank, and means for writing a first device identifier to the first memory device via a data path coupled to the first memory device and a second memory device while the device identifier assignment command is asserted on the command path. The apparatus also includes means for writing a second device identifier to the second memory device via the data path while the device identifier assignment command is asserted on the command path.

Referring again to FIG. 1, the means for asserting the device identifier assignment command on the command path may include a command path protocol in which a new command is included for the purpose of separately addressing one of the memory devices 104 in a rank 102. The means for asserting the device identifier assignment command on the command path 116 may also include the memory controller 114 coupled to first and second ones of the memory devices 104 as show in FIG. 1. Each of the memory devices 104 may be configured to implement the command path protocol, for example.

The means for writing the first device identifier to a first one of the memory devices 104 and means for writing the second device identifier to a second one of the memory devices 104 may include the memory controller 114 configured to send the first device identifier and the second device identifier on the data path 110 while the device identifier assignment command is asserted on the command path 116. The first device identifier may be sent on portions of the data path that are coupled to the first device (e.g., bits 0-15 of a 32 bit wide data path) and the second device identifier may be sent on portions of the data path 110 that are coupled to the second one of the memory devices 104 (e.g., bits 16-31 of the 32 bit wide data path).

The apparatus may also include means for including the first device identifier in a device identifier field of a memory command and means for asserting the memory command on the command path. The means for including the first device identifier in the device identifier field of the memory command and means for asserting the memory command on the command path may include the memory controller 114 configured to implement the expanded command path protocol in which certain memory commands are expanded to include a memory device identifier field, for example. In another aspect, the aforementioned means may be any module or any apparatus configured to perform the functions recited by the aforementioned means.

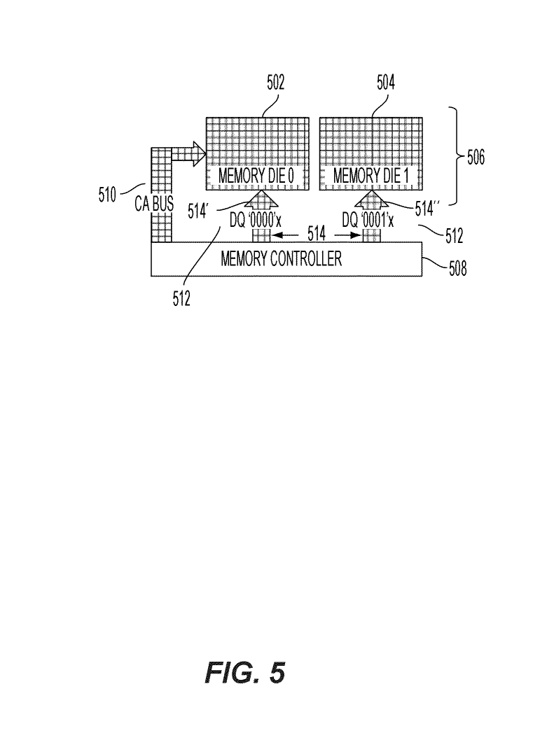

According to another aspect of the present disclosure, an existing command path protocol is modified to include an additional process to address different devices within a rank. A method for addressing different devices within a rank according to this aspect of the present disclosure is described with reference to FIG. 5. During normal operation, a signal 512 is sent on the DQ path 514 to select which memory devices (e.g., the first memory device 502 or the second memory device 504) in a rank 506 are to execute a command that is sent at substantially the same time on the command path 510. A first portion 514′ of the DQ path 514 is coupled to the first memory device 502 and a second portion 514″ of the DQ path 514 is coupled to the second memory device 504. The signal 512 on the DQ path 514 includes a first portion of the signal on the first portion 514′ of the DQ path and a second portion of the signal on the second portion 514″ of the DQ path 514. The signal 512 includes bits on each portion of the DQ path 514 that are configured for selecting or not selecting the respective memory device (e.g., the first memory device 502 or the second memory device 504) in the rank 506.

According to the additional process in the modified command path protocol, the first portion 514′ of the DQ path 514 is sampled by the first memory device 502 and the second portion of the data path is sampled by the second memory device 504 to determine whether the first memory device 502 or the second memory device 504 should execute the command For example, in one implementation, the command is not executed by a memory device (e.g., the first memory device 502 or the second memory device 504) if all bits on the first portion 514′ or the second portion 514″ of the DQ path 514 are ‘0’, but the command is executed if any bits on the first portion 514′ or the second portion 514″ of the DQ path 514 are ‘1’. According to this aspect of the present disclosure, multiple commands may be sent with different DQ coding to uniquely address different memory devices (e.g., the first memory device 502 or the second memory device 504) within a rank 506.

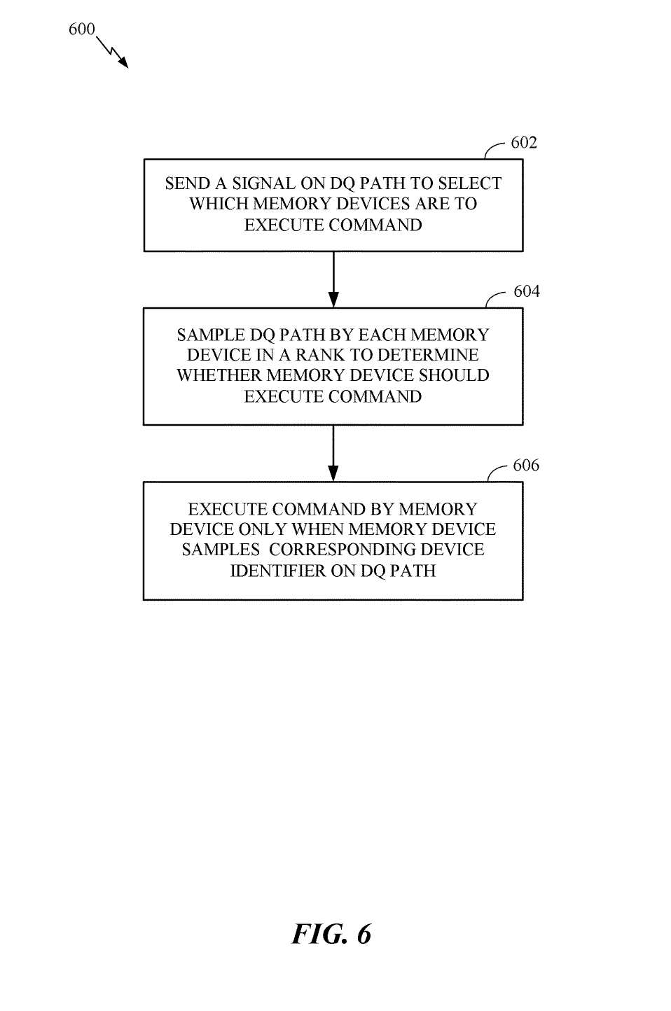

According to another aspect of the present disclosure, an existing command path protocol is modified to include an additional process to address different devices within a rank. FIG. 6 illustrates a method 600 for addressing different devices within a rank according to an aspect of the present disclosure. At block 602, during normal operation, a signal is sent on the DQ path to select which memory devices are to execute the command According to the additional process in the modified command path protocol, at block 604, the DQ path is sampled by each memory device in a rank to determine whether the memory device should execute the command For example, the command would not be executed by a memory device if all its DQ bits are ‘0’, but would be executed if all DQ bits are ‘1’. According to this aspect of the present disclosure, multiple commands may be sent with different DQ coding to uniquely address different memory devices within a rank.

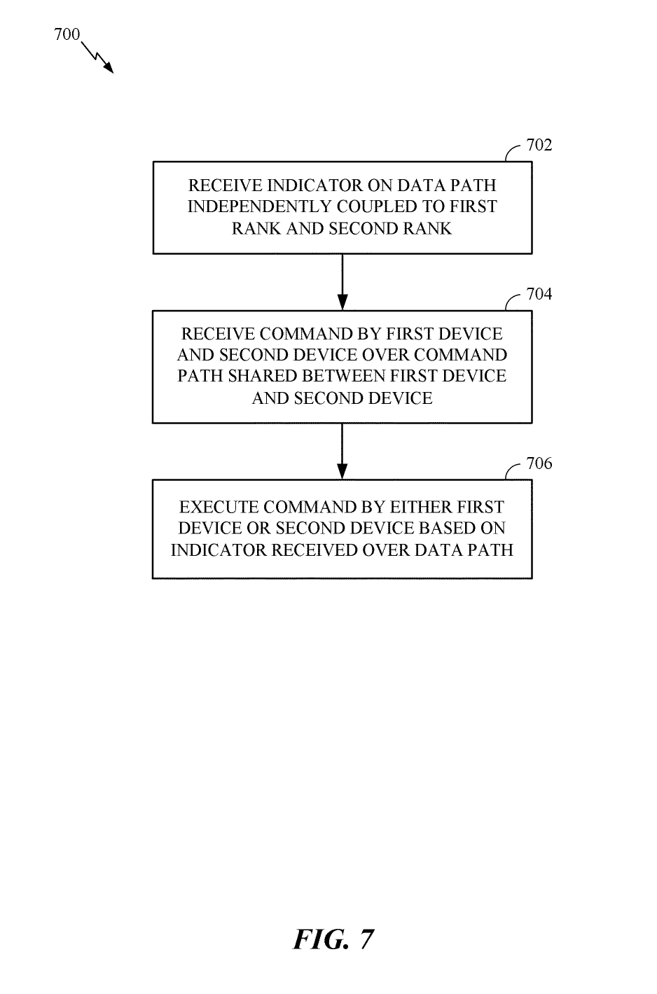

FIG. 7 illustrates a method 700 of sending independent commands to multiple memory devices within a rank, according to this aspect of the present disclosure. The method includes receiving an indicator on a data path independently coupled to a first device in a rank and a second device in the rank at block 702. At block 704, the method includes receiving a command by the first device and the second device over a command path shared between the first device and the second device. At block 706, the method includes executing the command by either the first device or the second device based on the indicator received over the data path.

A standard calibration process called “ZQ calibration” is generally used to calibrate DRAM devices. A memory controller coupled to the DRAM can initiate a ZQ calibration process at various times to account for changes in the system environment. ZQ calibration involves coupling an external precision resistor called a ZQ resistor between a dedicated ZQ calibration path of a DRAM package and an external node such as a ground node or a positive voltage value. For example, the dedicated ZQ path includes a dedicated ZQ ball or dedicated ZQ pin on the DRAM package.

A conventional package on package (PoP) apparatus includes dynamic random access memory (DRAM) in a top package coupled to processor circuitry including a memory controller circuitry in a bottom package. ZQ calibration paths couple the DRAM to corresponding external ZQ resistors on a system printed circuit board (PCB). The ZQ calibration paths conventionally extend from one or more DRAM dies in the top package through a bottom package of the PoP apparatus to the system PCB where they are coupled to the external ZQ resistors on the system PCB.

Each memory device in the top package may include its own ZQ calibration path. Conventionally, each ZQ calibration path includes a top conductive interface such as a solder ball coupled between the top package and bottom package and a bottom conductive interface such as a solder ball coupled between the bottom package and the system PCB.

In a conventional PoP, ZQ commands are sent at different times to different ranks by steering the ZQ commands with CS signals. Conventionally, memory devices within a rank are not addressed separately because they are share a CA bus, so they receive the same ZQ command at the same time. To avoid conflicts in which different memory devices within a rank access the same calibration resistor at the same time, the different memory devices within a rank are coupled to separate calibration paths and separate calibration resistors. This increases the number of calibration paths.

The ability to address memory devices within a rank separately according to aspects of the present disclosure provides the capability to send separate ZQ commands to memory devices within a rank so that those memories could share a ZQ resistor. In one example, according to aspects of the present disclosure, multiple calibration paths supporting different memory dies within a system rank are coupled together inside a bottom package of a PoP. The joined calibration paths are coupled to a shared external calibration resistor.

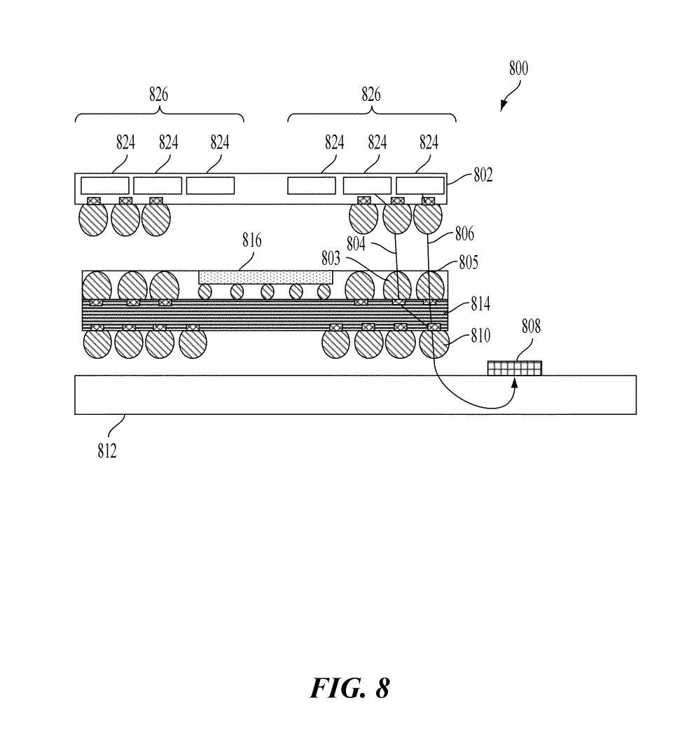

FIG. 8 is a block diagram illustrating a package on package (PoP) apparatus 800 according to an aspect of the present disclosure. In this configuration, the PoP apparatus 800 includes multiple dynamic random access memory (DRAM) devices 824 in a top package 802. The multiple DRAM devices 824 are assigned to different ranks 826. ZQ calibration paths 804, 806 couple different DRAM devices 824 in a rank 826 to a shared external ZQ resistor 808 on a system printed circuit board (PCB) 812. The ZQ calibration paths 804, 806 extend from one or more DRAM devices on the top package 802 to a bottom package 814 of the PoP 800. A shared bottom conductive interface 810 couples the ZQ calibration paths 804, 806 to the system PCB 812 and to a shared external ZQ resistor 808 on the system PCB 812. The bottom package 814 includes a processor system 816, coupled to the DRAM in the top package 802. The processor system 816 may include an MSM series processor or an APQ series processor by Qualcomm Corporation, of San Diego, Calif., for example.

Each of the ZQ calibration paths 804, 806 includes a top conductive interface 803, 805 such as a solder ball coupled between the top package 802 and the bottom package 814. A shared bottom conductive interface 810, such as a solder ball between the bottom package 814 and the system PCB 812, joins the ZQ calibration paths 804, 806 to a shared external ZQ resistor 808 on the system PCB 812.

According to one aspect of the present disclosure, the implementation of first system memory device in a rank and the second memory device in a rank involves a top conductive interface 803, 805 coupled between the top package 802 and bottom package 814 for each additional memory device in a rank, but involves only a single one of the shared bottom conductive interface 810 coupled between the bottom package 814 and the system PCB 812.

A first ZQ command is directed to a first memory device in a rank and a second ZQ command is directed to a second memory device in the rank at different times. This reduces the number of calibration paths between a bottom package 814 of the PoP and the system PCB 812 that are used for calibrating ranks of memory that include multiple memory devices.

According to one aspect of the present disclosure, directing separate ZQ memory commands to the first memory device and the second memory device in the rank can be performed by sending a separate device identifier to each of the memory device via a data path during an initialization process, then including the device identifier of the desired memory device in a ZQ command on the command path. The memory devices are configured to execute the ZQ command only if the device identifier included in the ZQ command matches the device identifier that they received during the initialization process.

According to another aspect of the present disclosure, directing separate ZQ memory commands to the first memory device and the second memory device in the rank can be performed by sending a signal on the data path to select which memory devices are intended to execute the command In this implementation, the a respective portion of the data path is sampled by each memory device in a rank to determine which memory device should execute the ZQ command In one implementation, for example, the ZQ command is not executed by a memory device unless at least one of the data bits received by the device during the ZQ command is a “1’.

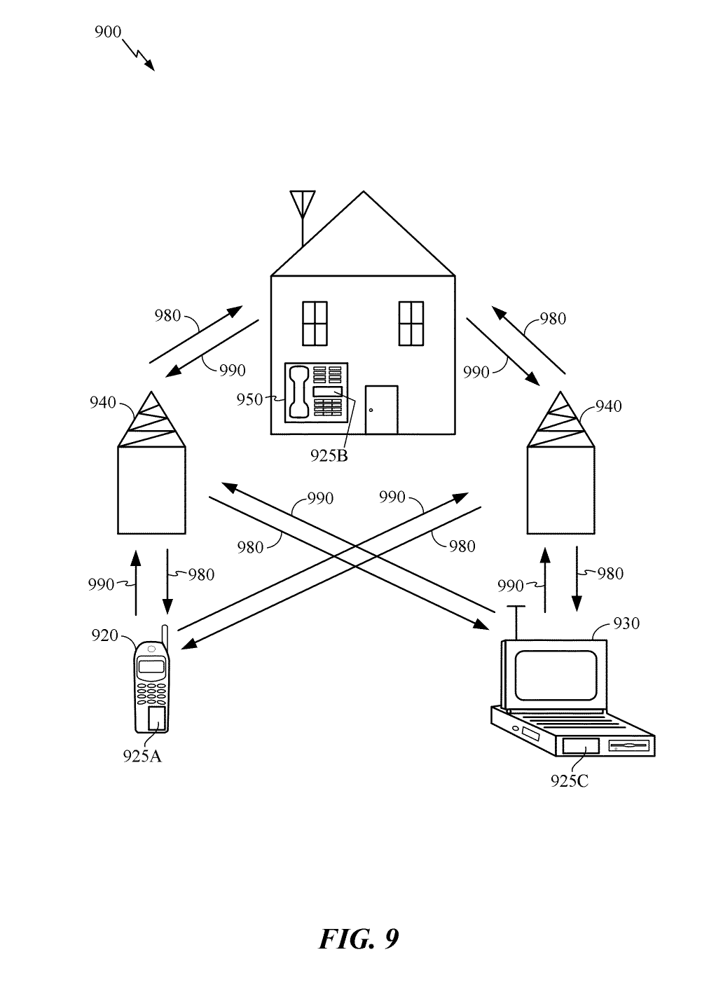

FIG. 9 is a block diagram showing an exemplary wireless communication system 900 in which an aspect of the disclosure may be advantageously employed. For purposes of illustration, FIG. 9 shows three remote units 920, 930, and 950 and two of the base stations 940. It will be recognized that wireless communication systems may have many more remote units and base stations. Remote units 920, 930, and 950 include IC devices 925A, 925C, and 925B that include the disclosed devices. It will be recognized that other devices may also include the disclosed devices, such as the base stations, switching devices, and network equipment. FIG. 9 shows forward link signals 980 from the base station 940 to the remote units 920, 930, and 950 and reverse link signals 990 from the remote units 920, 930, and 950 to base stations 940.

In FIG. 9, remote unit 920 is shown as a mobile telephone, remote unit 930 is shown as a portable computer, and remote unit 950 is shown as a fixed location remote unit in a wireless local loop system. For example, the remote units may be a mobile phone, a hand-held personal communication systems (PCS) unit, a portable data unit such as a personal data assistant, a GPS enabled device, a navigation device, a set top box, a music player, a video player, an entertainment unit, a fixed location data unit such as meter reading equipment, or other devices that store or retrieve data or computer instructions, or combinations thereof. Although FIG. 9 illustrates remote units according to the aspects of the disclosure, the disclosure is not limited to these exemplary illustrated units. Aspects of the disclosure may be suitably employed in many devices, which include the disclosed devices.

Although specific circuitry has been set forth, it will be appreciated by those skilled in the art that not all of the disclosed circuitry is required to practice the disclosed configurations. Moreover, certain well known circuits have not been described, to maintain focus on the disclosure.

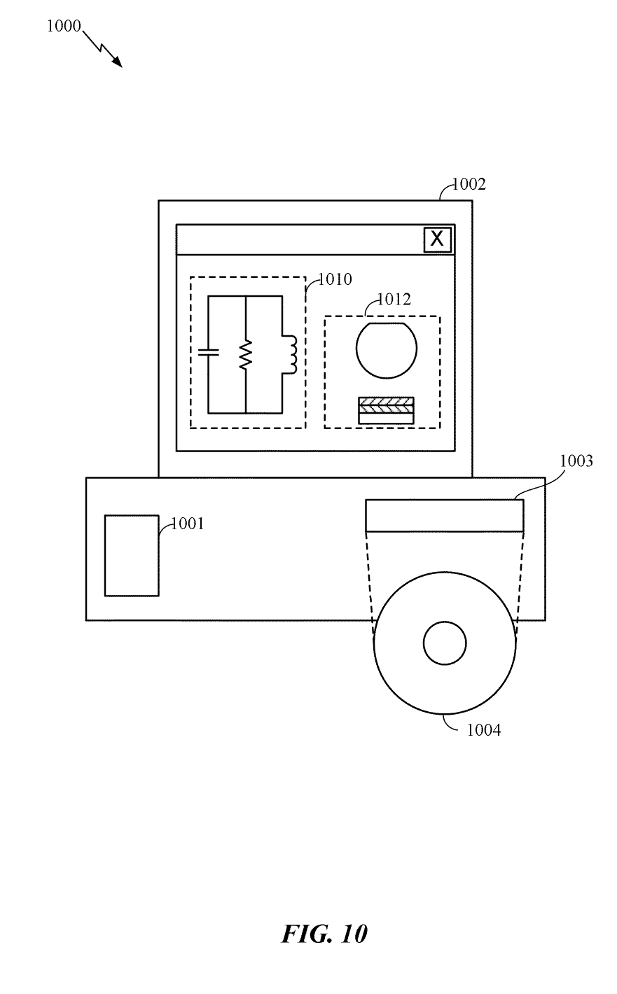

FIG. 10 is a block diagram illustrating a design workstation used for circuit, layout, and logic design of a semiconductor component, such as the memory system disclosed above. A design workstation 1000 includes a hard disk 1101 containing operating system software, support files, and design software such as Cadence or OrCAD. The design workstation 1000 also includes a display 1002 to facilitate design of a circuit 1010 or a semiconductor component 1012 such as the disclosed memory system. A storage medium 1004 is provided for tangibly storing the circuit design 1010 or the semiconductor component 1012. The circuit design 1010 or the semiconductor component 1012 may be stored on the storage medium 1004 in a file format such as GDSII or GERBER. The storage medium 1004 may be a CD-ROM, DVD, hard disk, flash memory, or other appropriate device. Furthermore, the design workstation 1000 includes a drive apparatus 1003 for accepting input from or writing output to the storage medium 1004.

Data recorded on the storage medium 1004 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1004 facilitates the design of the circuit design 1010 or the semiconductor component 1012 by decreasing the number of processes for designing semiconductor wafers.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term ‘memory’ refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method of sending independent commands to multiple memory devices within a rank, comprising:
assigning a first device identifier to a first memory device in the rank and a second device identifier to a second memory device within the rank by sending the first device identifier and the second device identifier on a data path coupled to the first memory device and the second memory device while an identifier assignment command is asserted on a command path shared between the first memory device and the second memory device; and
asserting the first device identifier on the command path to address the first memory device without addressing the second memory device.

2. The method of claim 1, further comprising:
including the first device identifier in a device identifier field of a memory command.

3. The method of claim 1, further comprising integrating the multiple memory devices into a mobile phone, a set top box, a music player, a video player, an entertainment unit, a navigation device, a computer, a hand-held personal communication systems (PCS) unit, a portable data unit, and/or a fixed location data unit.

4. A method of controlling a memory system, comprising:
asserting a device identifier assignment command on a command path coupled to a first memory device and a second memory device within a rank;
writing a first device identifier to the first memory device via a data path coupled to the first memory device and the second memory device while the device identifier assignment command is asserted on the command path; and
writing a second device identifier to the second memory device via the data path while the device identifier assignment command is asserted on the command path.

5. The method of claim 4, further comprising:
assigning a default device identifier to the first memory device and the second memory device during a power-up process of the memory system.

6. The method of claim 4, further comprising:
asserting the first device identifier on the command path to address the first memory device without addressing the second memory device.

7. The method of claim 6, further comprising:
including the first device identifier in a device identifier field of a memory command; and
asserting the memory command on the command path.

8. The method of claim 7, further comprising:
checking the device identifier field by the first memory device; and
executing the memory command by the first memory device, in response to the device identifier field including the first device identifier.

9. The method of claim 8, further comprising:
checking the device identifier field by the second memory device; and
ignoring the memory command by the second memory device in response to the device identifier field not including the second device identifier.

10. The method of claim 6, further comprising:
asserting the second device identifier on the command path to address the second memory device without addressing the first memory device.

11. The method of claim 4, further comprising integrating the memory system into a mobile phone, a set top box, a music player, a video player, an entertainment unit, a navigation device, a computer, a hand-held personal communication systems (PCS) unit, a portable data unit, and/or a fixed location data unit.

12. A method of sending independent commands to multiple memory devices within a rank, comprising:
receiving an indicator on a data path independently coupled to a first device in the rank and a second device in the rank;
receiving a command by the first device and the second device over a command path shared between the first device and the second device; and
executing the command by either the first device or the second device based at least in part on the indicator received over the data path.

13. The method of claim 12, further comprising integrating the multiple memory devices into a mobile phone, a set top box, a music player, a video player, an entertainment unit, a navigation device, a computer, a hand-held personal communication systems (PCS) unit, a portable data unit, and/or a fixed location data unit.

14. A semiconductor package on package (PoP) apparatus, comprising:
a first package including a first memory controller;
a second package coupled to the first package, the second package including a first memory device within a rank and a second memory device within the rank;
a command path coupled to the first memory device and the second memory device;
a first portion of a data path coupled to the first memory device;
a second portion of the data path coupled to the second memory device;
means for asserting a device identifier assignment command on the command path;
means for writing a first device identifier to the first memory device via the data path while the device identifier assignment command is asserted on the command path; and
means for writing a second device identifier to the second memory device via the data path while the device identifier assignment command is asserted on the command path.

15. The apparatus of claim 14, further comprising:
means for asserting the first device identifier on the command path to address the first memory device without addressing the second memory device.

16. The apparatus of claim 15, comprising:
means for including the first device identifier in a device identifier field of a memory command; and
means for asserting the memory command on the command path.

17. The apparatus of claim 16, comprising:
means for checking the device identifier field by the first memory device; and
means for executing the memory command by the first memory device, in response to the device identifier field including the first device identifier.

18. The apparatus of claim 17, comprising:
means for checking the device identifier field by the second memory device; and
means for ignoring the memory command by the second memory device in response to the device identifier field not including the second device identifier.

19. The apparatus of claim 15 comprising:
means for asserting the second device identifier on the command path to address the second memory device without addressing the first memory device.

20. The apparatus of claim 14, further comprising means for integrating the apparatus into a mobile phone, a set top box, a music player, a video player, an entertainment unit, a navigation device, a computer, a hand-held personal communication systems (PCS) unit, a portable data unit, and/or a fixed location data unit.
